(19) United States
(12) Patent Application Publication
(10) Pub. No.: US 2026/0298690 A1
(43) Pub. Date: Oct. 1, 2026

(54) LEVEL SENSING DEVICE HAVING MOLDED HOUSING AND COMPONENTS

(71) Applicant: Siemens Aktiengesellschaft, Munich (DE)

(72) Inventors: Timothy Coupland, Indian River (CA); Valentin Pantea, Newcastle (CA); Mihai-Gabriel Serban, North York (CA); George Quinton Lyon, Peterborough (CA)

(73) Assignee: Siemens Aktiengesellschaft, Munich (DE)

(21) Appl. No.: 19/093,524

(22) Filed: Mar. 28, 2025

(51) Int. Cl. G01F 23/284

(52) U.S. Cl. CPC G01F 23/284

(57) ABSTRACT

A level sensing device comprises a controller, a radar component mounted to the controller, and a radar module formed by encapsulation. The radar component includes a radio frequency source to emit a high frequency signal and a radio frequency sensor to receive a return signal corresponding to the high frequency signal. Utilizing low pressure molding, the radar component and the controller are encapsulated in a low pressure molding material that is also formed in a lens shape to realize a radar module antenna. The radar module antenna is positioned in an emitting path of the high frequency signal to direct the high frequency signal. The lens of the radar module is directed toward a target material to be measured by the radar component.

### TECHNICAL FIELD

This application relates to the field of level sensing devices and, more particularly, to a high frequency radar system for range finding and level sensing of bulk materials or fluids.

### BACKGROUND

Radars operating at high frequencies (HF) using integrated circuits need a housing for protection from external elements and conditions. Conventional devices assemble multiple plastic parts over the electronics to form the housing over the operational components.

In electronics, encapsulation or potting is the process of pouring liquid resin over electrical and electronic components, circuit boards and completed electronic assemblies for electrical insulation and to protect the product against thermal shock, vibration, moisture and corrosive substances. The process typically consists of many steps including a curing period. Depending on the product, higher temperatures can be used to reduce cure times, but this increases the risk of thermal damage. Potting compounds cure exothermically, and these cure reactions can generate heat to damage electronic components. It's not uncommon, for example, for potting compounds to heat up by 200° C. or higher, as they cure.

Aside from this risk of damage to components, potting can be a messy process that can have many other problems associated with it, not least of which is wastage.

### SUMMARY

In accordance with one embodiment of the disclosure, there is provided a low pressure molding approach for producing a high frequency radar. The low pressure molding is formed over electronics of the radar having a high frequency source generator. The low pressure molding material will form a lens to focus the high frequency signal and form a protective housing for the electronics. The low pressure material also forms elements to allow the unit to be installed in one or more intended applications.

One aspect is a level sensing device comprising a controller, a radar component, and a radar module. The radar component is mounted to the controller. The radar component includes a radio frequency source to emit a high frequency signal and a radio frequency sensor to receive a return signal corresponding to the high frequency signal. The radar module is formed via low pressure molding by encapsulating the radar component and the controller in a low pressure molding material. The radar module is also formed via the low pressure molding by forming the low pressure molding material in a lens shape to realize a radar module antenna, which is positioned in an emitting path of the high frequency signal to direct the high frequency signal. The radar module antenna of the radar module is directed toward a target material to be measured by the radar component.

Another aspect is a method of producing a level sensing device. A radar component is mounted to a controller. The radar component includes a radio frequency source to emit a high frequency signal and a radio frequency sensor to receive a return signal corresponding to the high frequency signal. A radar module is formed via low pressure molding by encapsulating the radar component and the controller in a low pressure molding material. The radar module is also formed by forming the low pressure molding material in a lens shape to realize a radar module antenna, which is positioned in an emitting path of the high frequency signal to direct the high frequency signal. The radar module antenna of the radar module is directed toward a target material to be measured by the radar component.

Yet another aspect is a non-transitory computer readable medium including executable instructions which, when executed, causes at least one processor to produce a level sensing device by the method(s) described herein.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIGS. 1A, 1B, and 1C are illustrations of high frequency radar systems in example implementations that are operable to employ techniques described herein.

FIG. 2 is a side view of an example implementation of the high frequency radars of FIGS. 1A-1C showing internal components within the external housing.

FIG. 3 is another side view of an example implementation of the high frequency radars of FIGS. 1A-1C shown within an encapsulating mold.

FIG. 4 is a flow diagram representing an example implementation of an operation of the high frequency radar system of FIGS. 1A-1C.

### DETAILED DESCRIPTION

Various technologies that pertain to systems and methods that facilitate low pressure molding for producing a high frequency radar will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

The high frequency radar system includes an integral lens and housing for a radar device using low pressure molding (“LPM”), eliminating the need for separate construction and assembly of the housing and the lens. LPM is a molding process in which a molding material is injected into a mold at significantly lower pressure than traditional injection molding, typically 40 bars (580 psi) or less. LPM provide gentle encapsulation and protection of sensitive parts to minimize any damage caused by pressure during molding while shielding them from their external environment during operation. In addition, a thermal transfer label may be molded into the product in which the molding material is transparent or non-transparent. A radar component, such as an integrated circuit and/or antenna, and a controller, such as a circuit board or other electronics, are encapsulated by the molded housing. The radar component emits a high frequency signal through the molded lens toward a target material to be measured. Example materials for mold pressure molding include, but are not limited to, polyamide based materials, polyolefin based materials, or other moldable plastics.

The high frequency radar system utilizes low pressure over molding, which is a fast, clean and low cost approach, to avoid the problem associated with encapsulation or potting. Low pressure over molding utilizes significantly less steps than potting, thus reducing manufacturing time, labor and material costs and improving throughput, resulting in increased return on investment. There is zero waste, scrap is often recyclable and the process is environmentally friendly, giving off minimal toxic fumes. The end result is a tamperproof and environmentally sealed product.

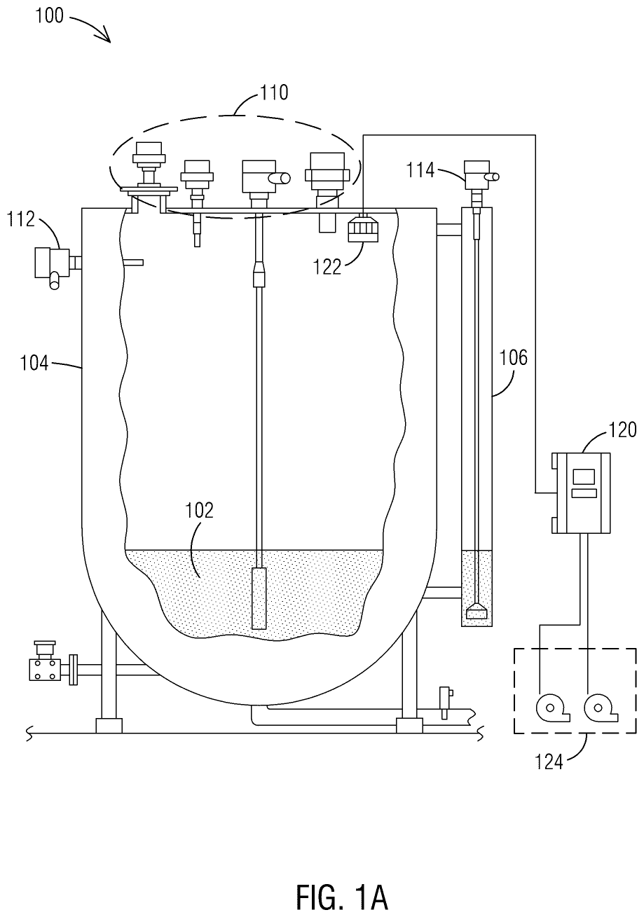

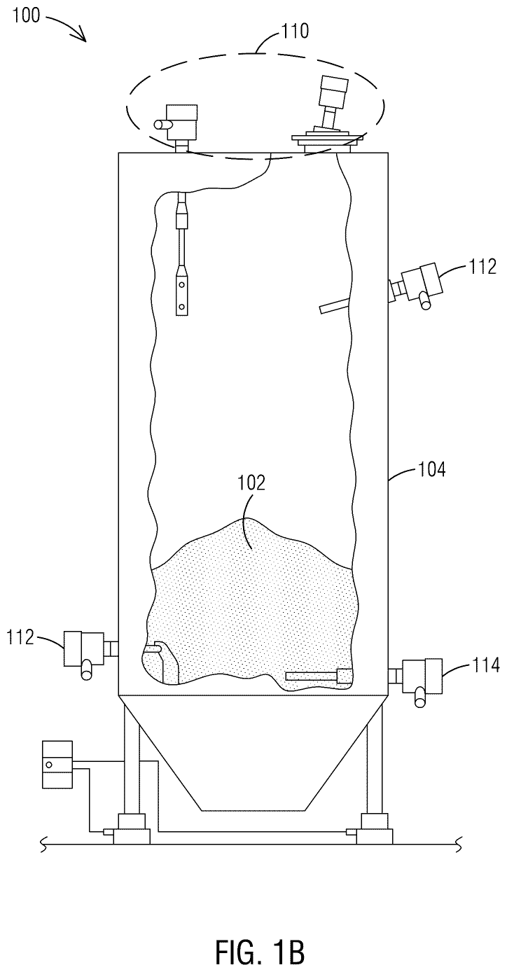

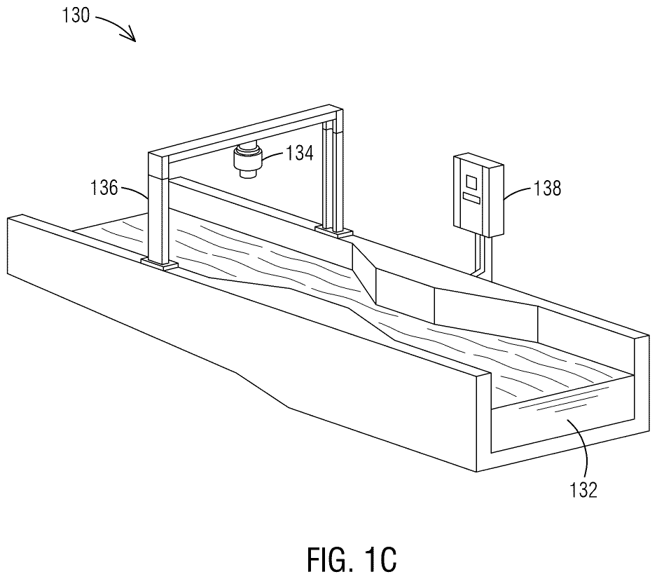

Referring to FIGS. 1A, 1B, and 1C, there are shown high frequency radar systems 100 for range finding and level sensing of target materials 102, such as bulk materials or fluids. Radar systems 100 for level measurement determine the amount or level of the target material 102 at a given location. A radar system 100 may determine the length, width, depth, area, and/or volume of the target material. For example, the radar system 100 may deriving a volume of the material in a container 104 based on information relating to the target material 102 and the container by the system. The radar system 100 may also determine the level of target material 102 in an auxiliary container 106 associated with the primary container 104 for separate or cooperative measurements of the target material 102.

Referring to FIGS. 1A and 1B, the high frequency radar systems 100 includes one or more radar modules 110, 112, 114 for range finding and level sensing of target materials 102. Each radar module 110, 112, 114 is directed toward the target material 102 to be measured by the radar module. For some embodiments, the radar module 110, 112, 114 may be attached to a base structure of the container 104 or auxiliary container 106 to facilitate the ability direct high frequency signals toward the target material 102. One or more radar modules 110 may be attached to a top base structure that is located at a top portion of the container 104, 106 or otherwise above the target material 102. For example, embodiments, a radar module 112 may be attached to a side base structure that is located at a side portion of the container 104, 106 or otherwise at a location other than the top portion of the container. For some embodiments, the radar module 114 may be attached to an auxiliary base structure located at a portion of the auxiliary container 106.

The high frequency radar system 100 may further include a control system 120 for receiving the determined level of the target material 102 from a transponder module 122 co-located with one or more radar modules 110, 112, 114 and operate one or more external devices 124 in response to the determined level. Each external device 124 may report the determined level to a system user or operator, manage operating conditions of the target material 102 within a container 104, 106, or command external devices that may interact with the target material 102 and/or the container 104, 106.

Referring to FIG. 1C, some embodiments of the high frequency radar system 130 may be utilized for range finding and level sensing of dynamic target material 132. Similar to systems (100) for measuring other target materials 102, the system 130 for measuring the dynamic target material 132 may be attached to, or otherwise supported by, a base structure 136 to facilitate the ability direct high frequency signals toward the target material 132. The system 130 may further include a control system 138 for receiving the determined level of the target material 132 and operating one or more external devices in response to the determined level.

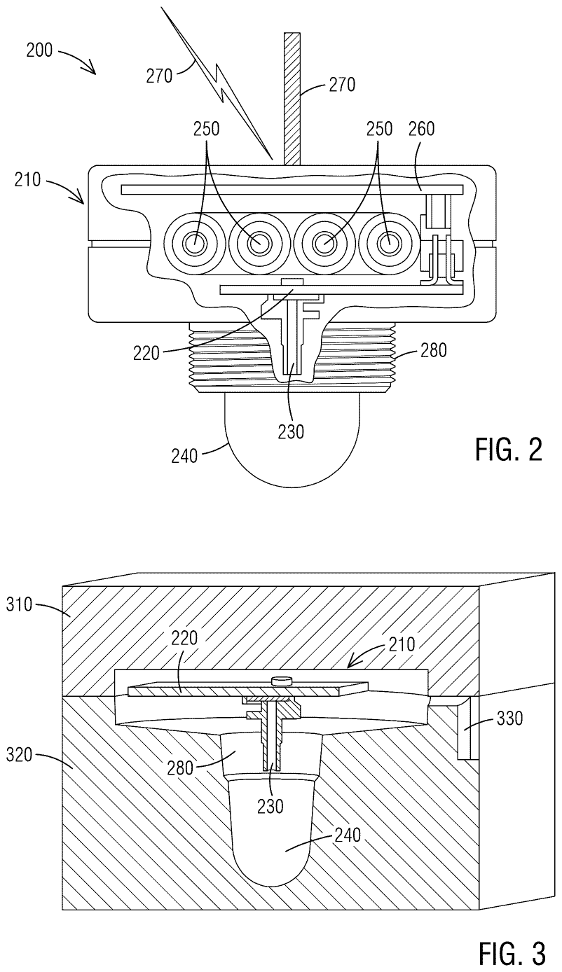

Referring to FIG. 2, there is shown a side view of an example implementation of the high frequency radars, namely a level sensing device 200, showing internal components within an externally molded housing. Although normally not visible from this external view, FIG. 2 illustrates the level sensing device 200 with certain internal components shown to facilitate ones understanding of the device.

The level sensing device 200 includes a radar module 210 enclosing a controller 220 and a radar component 230. In particular, the radar module 210 is formed via low pressure molding by encapsulating the radar component 230 and the controller 220 in a low pressure molding material. The encapsulation of the radar component 230 and the controller 220 provides a protective housing from an environmental external to the radar module 210. The low pressure molding also allows for forming the low pressure molding material in a shape of a lens 240 adjacent to, or at a particular distance from, the controller 220, so that the high frequency signal may be directed toward a distal focal point. The formation of the low pressure molding material in this lens shape realizes a radar module antenna that directs the high frequency signal. Before encapsulating these components via the low pressure molding, the radar component 230 is mounted to the controller 220. Accordingly, the radar component 230 may be preassembled to the controller 220 before the low pressure molding process. The radar component includes a radio frequency source to emit a high frequency signal and a radio frequency sensor to receive a return signal corresponding to the high frequency signal. For some embodiments, the radio frequency source of the radar component may operate in the K-band or greater.

The radar module antenna, including the lens 240, of the radar module is directed toward a target material to be measured by the radar component so that the high frequency signal will be directed toward the target material as well. The controller 220 of the level sensing device 200 may determines a level of the target material by processing the return signal. The controller 220 may also, or in the alternative, derive a volume of the target material in the container based on information related to the target material and the container. For example, the information may be stored at a memory component of the controller 220 and extracted therefrom for the derivation.

For some embodiments, the level sensing device 200 may include a power source and/or a communication transceiver. The power source 250 and/or the transceiver 260 may be coupled to the controller 220. An example of the power source 250 includes, but is not limited to, a battery pack. The transceiver may be a wired or wireless transceiver utilizing on a wired connection 270 or wireless technologies 270 such as Bluetooth or Narrowband Internet of Things (“NB-IoT”). The power source 250 and/or the transceiver 260 may be positioned external to, or molded via the low pressure molding in, the protective housing of the radar module 210. For embodiments where the power source 250 and/or the transceiver 260 may be external to the radar module 210, an upper housing may support the power source 250 and/or the transceiver 260. The radar module 210 and the upper housing may be coupled together, such as by an annular snap.

For some embodiments, the level sensing device 200 may include an external surface 280 molded in the protective housing for attachment to a base structure so that the radar module antenna, including the lens 240, of the radar module is directed toward the target material to be measured by the radar component.

Referring to FIG. 3, there is shown another side view of an example implementation of the level sensing device 200 shown within an encapsulating mold, such as a mold tool 300. The level sensing device 100 may include a variety of components as described above but, for simplification of understanding, only the front end of the device is represented as being molded in FIG. 3. It is to be understood that the mold tool may be used to form the radar module 210 with or without other components such as the power source 250 and transceiver 260.

Low pressure molding is an injection process where electronic parts and other sensitive components are placed in a specially manufactured mold tool, i.e., the mold tool 300. The mold tool 300 comprises of a solid material that maintains its inner shape during the molding process, such as, but not limited to, aluminum. For some embodiments, the mold tool 300 includes a first mold portion 310 and a second mold portion 320 that combine to form the radar module 210 or other level sensing device 200 within the confines of their inner surfaces and separate the release the module or device after the molding process is complete. The low pressure molding completely surrounds the assembly or parts with a low pressure molding material, such as a liquified mold compound, filling the mold tool 300 that effectively forms the housing for the system or device. The liquified mold compound may enter the inner surface or surfaces of the mold tool 300 via a conduit 330 between the external and internal areas of the mold tool.

Low pressure molding material or potting material is used to encase an electronics assembly which contains a high frequency source. The low pressure molding material would form a protective housing but would be designed as well to form a high frequency focusing lens 240 to focus the high frequency energy leaving the unit. The molding material would also be designed to form mounting elements, such as the external surface 280, used to allow attachment of the unit to an attended application. The production process of the level sensing device 200 is simplified by integrating multiple parts in the molded product. Components such as electronics may be surface mounted or otherwise preassembled before being over molded to minimize manual assembly.

The maximum range of the radar component may be nominal with an opening angle of about + or −70 degrees. The lens 240 of the level sensing device 200 focus the high frequency signal emitted by the radar component 230 such that the opening angle of the radar lob may be reduced. With this lens 240, the opening angle of some embodiments may decrease to about + or −4 degrees and the range may be significantly increased. The radar module antenna or lens 240 may be mounted directly on the radar component 230 or positioned in proximity to the radar component. For some embodiments, the lens may be placed above the transceiver IC in direct contact with the IC in which an adhesive between the lens and the radar component 230 is lateral to the radar component or otherwise not in the path of RF transmission.

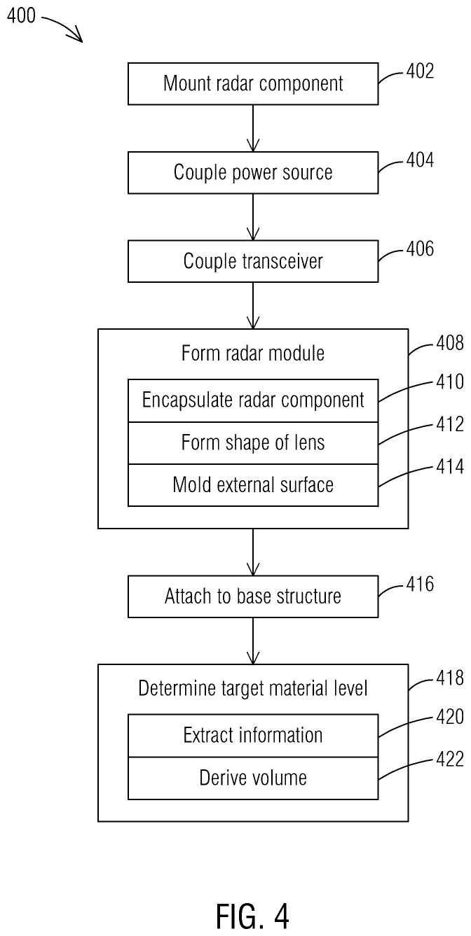

FIG. 4 is a flow diagram representing an example implementation of an operation of the high frequency radar system, including a method 400 of producing the level sensing device 200. Components of the level sensing device 200 are combined before the low pressure molding process. When combining, the radar component 230 is mounted (402) to the controller 220. The radar component 230 includes a radio frequency source to emit a high frequency signal and a radio frequency sensor to receive a return signal corresponding to the high frequency signal. For some embodiments, a power source 250 may be coupled (404) to the controller 220. For some embodiments, a wired or wireless transceiver 260 may be coupled (406) to the controller 220.

Subsequent to, or in response to, mounting (402) the radar component 230 to the controller 220, the radar module 210 is formed (408) via the low pressure molding. In particular, the radar module 210 may be formed by encapsulating (410) the radar component 230 and the controller 220 in a low pressure molding material to establish a protective housing for the level sensing device 200. Also, the radar module 210 may be formed by forming (412) the low pressure molding material in the shape of a lens 240 to realize a radar module antenna. The radar module antenna is position in an emitting path of the high frequency signal to direct the high frequency signal emitted by the radar component 230. For leveling sensing devices 200 that include the power source 250 and/or the transceiver 260, these components may be molded in the protective housing when the radar module 210 is formed (408). In particular, forming (408) the radar module 210 may include molding the power source in the protective housing and/or forming the radar module may includes molding the wired or wireless transceiver in the protective housing.

For some embodiments, forming (408) the radar module 210 includes molding (414) the external surface 280 of the protective housing via low pressure molding. As a result, the external surface 280 may be attached (416) to a base structure so that the radar module antenna or lens 240 of the radar module 210 is directed toward the target material 102, 132 to be measured by the radar component 230.

Subsequent to forming the radar module 408, the level sensing device 200 may be operated to determine (418) a level of the target material 102, 132. The level of the target material 102, 132 may be determined (418) by processing the return signal received by the radio frequency sensor to receive the return signal, in which the return signal corresponds to, and is in response to, the high frequency signal emitted by the radio frequency source. For some embodiments, the radio frequency source of the radar component 230 operates in the K-band or greater. For some embodiments, the level sensing device 200 may determine (418) the target material level by having the controller 220 extract, from a memory component of the controller, information relating to the target material 102, 132 and the container 104. The controller 220 may then derive a volume of the material 102, 132 in the container 104.

Those skilled in the art will recognize that, for simplicity and clarity, the full structure and operation of all data processing systems suitable for use with the present disclosure are not being depicted or described herein. Also, none of the various features or processes described herein should be considered essential to any or all embodiments, except as described herein. Various features may be omitted or duplicated in various embodiments. Various processes described may be omitted, repeated, performed sequentially, concurrently, or in a different order. Various features and processes described herein can be combined in still other embodiments as may be described in the claims.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an example embodiment of the present disclosure has been described in detail, those skilled in the art will understand that various changes, substitutions, variations, and improvements disclosed herein may be made without departing from the spirit and scope of the disclosure in its broadest form.

1. A level sensing device comprising:
a controller;
a radar component mounted to the controller, the radar component including a radio frequency source to emit a high frequency signal and a radio frequency sensor to receive a return signal corresponding to the high frequency signal; and
a radar module formed via low pressure molding by encapsulating the radar component and the controller in a low pressure molding material and forming the low pressure molding material in a lens shape to realize a radar module antenna, the radar module antenna being positioned in an emitting path of the high frequency signal to direct the high frequency signal,
wherein the lens of the radar module is directed toward a target material to be measured by the radar component.

2. The level sensing device as described in claim 1, further comprising a power source coupled to the controller and molded in the protective housing.

3. The level sensing device as described in claim 1, further comprising a wired or wireless transceiver coupled to the controller and molded in the protective housing.

4. The level sensing device as described in claim 1, further comprising an external surface molded in the protective housing and attached to a base structure so that the lens of the radar module is directed toward the target material to be measured by the radar component.

5. The level sensing device as described in claim 1, wherein the controller determines a level of the target material by processing the return signal.

6. The level sensing device as described in claim 1, wherein the controller extracts, from a memory component, information relating to the target material and the container, and the controller derives a volume of the material in the container.

7. The level sensing device as described in claim 1, wherein the radio frequency source of the radar component operates in the K-band or greater.

8. A method of producing a level sensing device comprising:
mounting a radar component to a controller, the radar component including a radio frequency source to emit a high frequency signal and a radio frequency sensor to receive a return signal corresponding to the high frequency signal;
forming a radar module via low pressure molding by encapsulating the radar component and the controller in a low pressure molding material and forming the low pressure molding material in a lens shape to realize a radar module antenna, the radar module antenna being positioned in an emitting path of the high frequency signal to direct the high frequency signal; and
directing the radar module antenna of the radar module toward a target material to be measured by the radar component.

9. The method as described in claim 8, further comprising coupling a power source to the controller, wherein forming the radar module includes molding the power source in the protective housing.

10. The method as described in claim 8, further comprising coupling a wired or wireless transceiver to the controller, wherein forming the radar module includes molding the wired or wireless transceiver in the protective housing.

11. The method as described in claim 8, wherein forming the radar module includes molding an external surface of the protective housing, the method further comprising:
attaching the external surface to a base structure so that the lens of the radar module is directed toward the target material to be measured by the radar component.

12. The method as described in claim 8, further comprising determining a level of the target material by processing the return signal.

13. The method as described in claim 8, further comprising:
extracting, from a memory component, information relating to the target material and the container by the controller; and
deriving a volume of the material in the container by the controller.

14. The method as described in claim 8, wherein the radio frequency source of the radar component operates in the K-band or greater.

15. A non-transitory computer readable medium including executable instructions which, when executed, causes at least one processor to produce a level sensing device by:
mounting a radar component to a controller, the radar component including a radio frequency source to emit a high frequency signal and a radio frequency sensor to receive a return signal corresponding to the high frequency signal;
forming a radar module via low pressure molding by encapsulating the radar component and the controller in a low pressure molding material and forming the low pressure molding material in a lens shape to realize a radar module antenna, the radar module antenna being positioned in an emitting path of the high frequency signal to direct the high frequency signal; and
directing the lens of the radar module toward a target material to be measured by the radar component.

16. The non-transitory computer readable medium as described in claim 15, causing the at least one processor to produce the level sensing device by coupling a power source to the controller, wherein forming the radar module includes molding the power source in the protective housing.

17. The non-transitory computer readable medium as described in claim 15, causing the at least one processor to produce the level sensing device by coupling a wired or wireless transceiver to the controller, wherein forming the radar module includes molding the wired or wireless transceiver in the protective housing.

18. The non-transitory computer readable medium as described in claim 15, wherein forming the radar module includes molding an external surface of the protective housing, the at least one processor further caused to produce the level sensing device by:
attaching the external surface to a base structure so that the lens of the radar module is directed toward the target material to be measured by the radar component.

19. The non-transitory computer readable medium as described in claim 15, causing the at least one processor to produce the level sensing device by determining a level of the target material by processing the return signal.

20. The non-transitory computer readable medium as described in claim 15, causing the at least one processor to produce the level sensing device by:
extracting, from a memory component, information relating to the target material and the container by the controller; and
deriving a volume of the material in the container by the controller.
